(19) United States
(12) Patent Application Publication
(10) Pub. No.: US 2004/0221162 A1
(43) Pub. Date: Nov. 4, 2004

(54) Method and systems to facilitate online electronic notary, signatures and time stamping

(75) Inventor: Phil Kongtcheu, Jersey City, NJ (US)

Correspondence Address: PHIL KONGTCHEU, PFK TECHNOLOGIES, 1866 JOHN F. KENNEDY BOULEVARD SUITE B1, JERSEY CITY, NJ, 07305, US

(73) Assignee: Phill Kongtcheu, Jersey City, NJ

(21) Appl. No.: 10/770,589

(22) Filed: Feb. 3, 2004

Related U.S. Application Data
(60) Provisional application No. 60/444,374, filed on Feb. 3, 2003.

(51) Int. Cl. H04L 9/00

(52) U.S. Cl. 713/178

(57) ABSTRACT

This invention relates to methods and systems to facilitate online electronic notary, signatures and time stamping services. A novel feature is enabling the creation of signed, time stamped or notarized documents having the appearance onscreen or in print of manually generated ones.

### CROSS-REFERENCE TO RELATED APPLICATIONS

This Patent Application claims the benefit of Provisional Patent Application No. 60/444,374 filed on Feb. 3, 2003.

### STATEMENT REGARDING FEDERALLY SPONSORED RESEARCH OR DEVELOPMENT

None

### REFERENCE TO A “SEQUENCE LISTING,” A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC

None

### BACKGROUND OF THE INVENTION

Prior art related to the invention are U.S. Pat. No. 5,781,629, U.S. Pat. No. 6,587,945 and U.S. Pat. No. 5,022,080. These patents provides various mechanisms for securely time stamping a document, securely verifying/authenticating reviews of a digital document and more generally securing the electronic notary process. There appears to viable alternatives in the public domain. The present invention innovates in its ability to provide secure electronic notary, signature and time stamp compliant with the E-sign act while at the same time generating a paper trail that maintains the look and feel of paper signed and/or notarized document.

The main other referenced document is the E-Sign Act, S, ENR 761 of the 106^{th} congress of the united states.

The US and International laws are rapidly evolving in response to the electronic information revolution. Accommodations to allow and encourage electronic transactions are in the works. The efforts to acknowledge the validity and enforceability of electronic signatures and electronically-entered contracts are just two of the many examples where lawmakers are demonstrating their appreciation of the contribution to commerce electronic transactions can provide. The “E-Sign” enacted on Oct. 1, 2000 is a specific example of the statement legislatures are making in the support of the value electronically mediated transactions. Section 101 (a) states:

IN GENERAL—Notwithstanding any statute, regulation, or other rule of law (other than this title and title II), with respect to any transaction in or affecting interstate or foreign commerce

(1) a signature, contract, or other record relating to such transaction may not be denied legal effect, validity, or enforceability solely because it is in electronic form, and

(2) a contract relating to such transaction may not be denied legal effect, validity, or enforceability solely because an electronic signature or electronic record was used in its formation.

In doing so, the legislator meant to encourage private initiatives aimed at using electronic means to replace existing hand-written ways of giving legal effects to signatures or contracts, Specifically, in section 101(g), the bill addresses the issue of electronic notarization and the requirements to be met:

(d) Retention of Contracts and Records

(1) ACCURACY AND ACCESSIBILITY—If a statute, regulation, or other rule of law requires that a contract or other record relating to a transaction in or affecting interstate or foreign commerce be retained, that requirement is met by retaining an electronic record of the information in the contract or other record that—(A) accurately reflects the information set forth in the contract or other record; and (B) remains accessible to all persons who are entitled to access by statute, regulation, or rule of law, for the period required by such statute, regulation, or rule of law, in a form that is capable of being accurately reproduced for later reference, whether by transmission, printing, or otherwise.

(2) EXCEPTION—A requirement to retain a contract or other record in accordance with paragraph (1) does not apply to any information whose sole purpose is to enable the contract or other record to be sent, communicated, or received.

(3) ORIGINALS—If a statute, regulation, or other rule of law requires a contract or other record relating to a transaction in or affecting interstate or foreign commerce to be provided, available, or retained in its original form, or provides consequences if the contract or other record is not provided, available, or retained in its original form, that statute, regulation, or rule of law is satisfied by an electronic record that complies with paragraph (1).

(4) CHECKS—If a statute, regulation, or other rule of law requires the retention of a check, that requirement is satisfied by retention of an electronic record of the information on the front and back of the check, in accordance with paragraph (1),

(e) Accuracy and Ability to Retain Contracts and Other Records

Notwithstanding subsection (a), if a statute, regulation, or other rule of law requires that a contract or other record relating to a transaction in or affecting interstate or foreign commerce be in writing, the legal effect, validity, or enforceability of an electronic record of such contract or other record may be denied if such electronic record is not in a form that is capable of being retained and accurately reproduced for later reference by all parties or persons who are entitled to retain the contract or oilier record.

(f) PROXIMITY—Nothing in this title affects the proximity required by any statute, regulation, or other rule of law with respect to any warning, notice, disclosure, or other record required to be posted, displayed, or publicly affixed.

(g) NOTARIZATION AND ACKNOWLEDGMENT: If a statute, regulation, or other rule of law requires a signature or record relating to a transaction in or affecting interstate or foreign commerce to be notarized, acknowledged, verified, or made under oath, that requirement is satisfied if the electronic signature of the person authorized to perform those acts, together with all other information required to be included by other applicable statute, regulation, or rule of law, is attached to or logically associated with the signature or record,

(h) ELECTRONIC AGENTS—A contract or other record relating to a transaction in or affecting interstate or foreign commerce may not be denied legal effect, validity, or enforceability solely because its formation, creation, or delivery involved the action of one or more electronic agents so long as the action of any such electronic agent is legally attributable to the person to be bound.

This invention has been developed to strictly comply with the provisions of the e-Sign Law as our description below shows:

### BRIEF SUMMARY OF THE INVENTION

This invention relates to the use of electronic means in the signature and/or notarization of documents. One great advantage with electronic notarization is the convenience and efficiency an electronic notary can provide. An individual seeking to have papers notarized can save the time and expense of leaving an office, traveling through a business district during rush hour, waiting in an office, and returning to work simply in the quest of having a notary authenticate documents. The inconvenience ultimately results in lost of productivity and additional costs to the customer. Furthermore, an electronic notary is available 24 hours a day, seven days a week. It goes without saying such a service would be highly useful.

This invention describes and teaches a system and method for providing an electronic notary service in compliance with the provision of the e-sign law and the general state law regarding the performance of electronic services. A key aspect of this invention is that it will enable the electronic system and method to produce permanent, fully compliant, un-editable e-notarized documents with a look and feel of the traditional manual service in sharp contrast for instance to the method used by companies such as Surety.com and it U.S. Pat. No. 5,781,629 patent. Such a feature will promote acceptance among those users otherwise uncomfortable with the notion of e-notarizing. Additionally, the invention enables the formation of a community or network of e-notaries who can support one another and extend services to an individual client throughout the country. Even county administrators, government agencies, and anyone in the stream of a transaction may be able to access and take advantage of the convenience that an electronically mediated network can provide. Finally, the invention provides for a recording system to archive notarized documents.

### BRIEF DESCRIPTION OF THE SEVERAL VIEWS OF THE DRAWING

FIG. 1. shows a sample of electronic tools and features available to the electronic notary and a demonstration of just one example on how the features can be placed. The features options allow a Notary to create the look and feel of a traditionally notarized document.

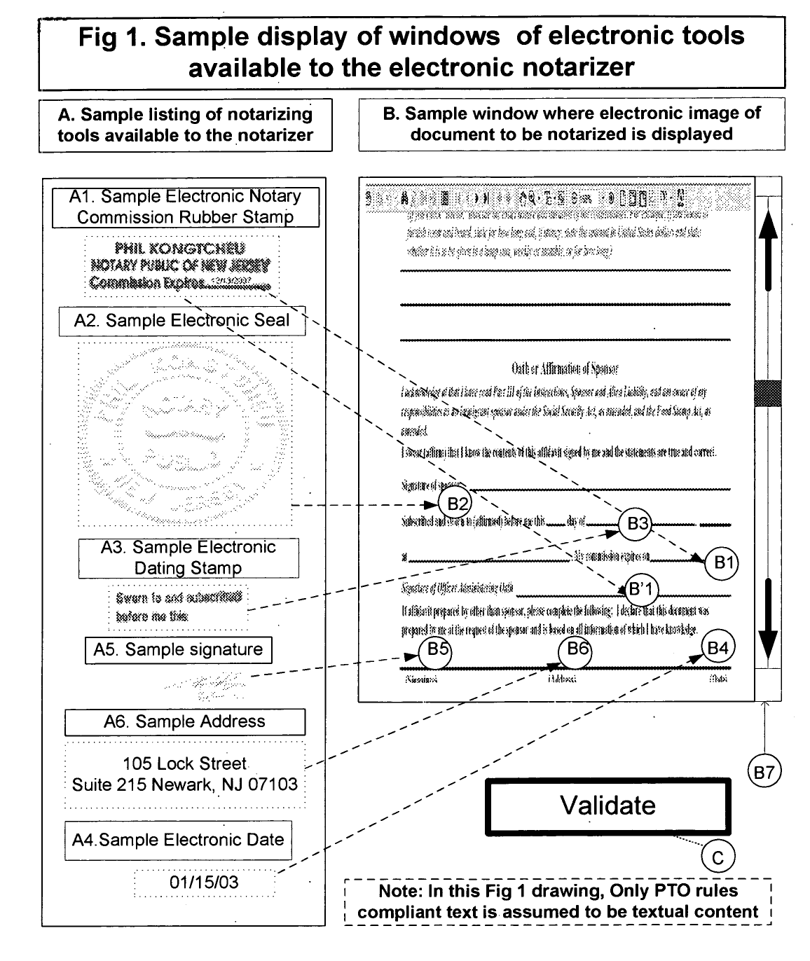

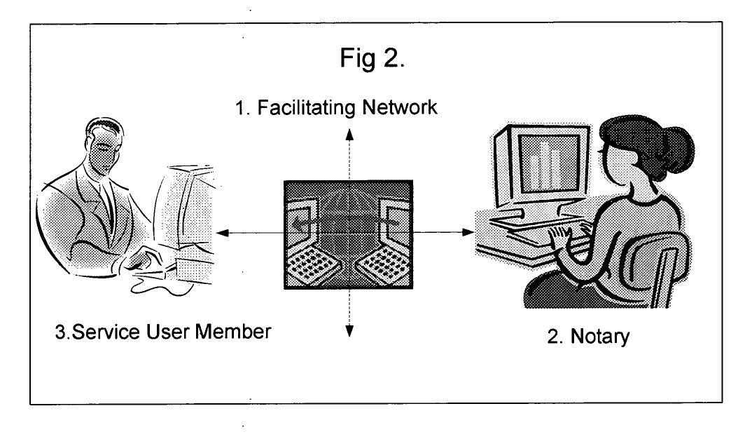

Portions A1-A6 show a sample of some of the tools available to a user.

B1 through B6 show how these can be placed by a user on the final e-notarized document.

B7 is a tool to navigate the page. Electronic validation is implemented by the button as shown in C.

A1: A user can establish an electronic stamp to simulate the appearance of a traditional manual rubber stamp. The information in this example shows the name of the notary, the commission number, and the state where the notary is commissioned.

A2: A user can choose or design an electronic seal and can place the seal anywhere on the electronically notarized document.

A3: The date stamp option allows the notary to place the “sworn to” statement anywhere on the document.

A4-A6: The date, signature, and address of the Notary.

FIG. 2. Schematically presents the three principal actors involved in the present invention:

1. The facilitating network probably operating the business enabled by our invention

2. The one or more commissioned notaries apposing seal, time stamps or signature to document to be notorized or initially identifying service user members

3. The one or more service user members who needs to sign, time stamp, edit or notarize a document.

### DETAILED DESCRIPTION OF THE INVENTION

The invention facilitates initial identification of network service users (members) through an identification transitivity principle among networks of commissioned notaries whereby a member, appropriately physically identified by a notary of the network, is considered adequately identified by the other notaries or service users of the network. The invention comprises a step for initially identifying notaries by verification of their notary commission, for example through initial production notary commission documents and official identification documents and cross verification with local/state/federal government.

The invention also includes steps for subsequently identifying notaries and/ or members through verification of a combination of one or more of the following: name/password, smart card, biometric identifiers (fingerprint, handwriting, face recognition, eye recognition, handwriting, etc. . . ).

The invention also includes a step for generating notary seals, time stamps, signatures, images and text with the appearance on-screen and/or paper of a manually applied seal, signature, time stamp, text or image. The invention also includes the flexibility to appose any of the above items at any designated location of an original document and/ or generate its copy.

The invention also includes a step for generating electronic records of signed, time-stamped or notarized documents. In compliance with the e-sign law, or those of any other country on similar matters, those records may be kept in the form of image files of signed documents or compressed digital fingerprints computed using a variety of mathematical algorithms that practically uniquely identify the original document, its image file, and all relevant signatures, time stamps or notary seals applied to it.

A preferred embodiment of the present invention includes a verification method or system whereby an auditor can check the authenticity of notary, signature or time stamp by submitting a system generated image file of the original document. The system would then compute its one or more digital fingerprints and check it against its digital fingerprint record(s) of the document. A positive verification statement is issued if there is a match and a negative identification statement is otherwise issued.

A preferred embodiment of the present invention may include for each document signed, means for obtaining history listing all editions of the document notarized, signed or time stamped with time and author information. These means include a separate file appended to the document or provided each time the document file is submitted to a reference website for verification.

In a preferred embodiment of the present invention, for privacy preservation purposes, the managing system would not keep in its records, actual copies of time stamped, signed or notarized documents. These would only be available to the service user members. Rather, the managing system may only keep in its own records, digital fingerprints of those. However, the managing system may also record history log of these documents or include means for generating them from information recorded. The history log would be recorded in connection to the digital fingerprints created.

A preferred embodiment of the present invention may be developed in conjunction with electronic invention record maintenance and electronic invention disclosures certification:

An inventor, properly initially identified and subsequently authenticated as herein disclosed for service user members of an electronic notarization network, may create a disclosure of their invention. This disclosure created in any file format may then be submitted to the network using for instance a method as disclosed in Provisional Patent Application Ser. No: 60/444,257 filed on Feb. 3, 2003 and its derivative PCT US03/. . . After conversion into a PDF file and time stamping, the record would then be further signed and/or notarized.

Example of Computer Implementation

In a computerized system, a user uploads a scanned document to be notarized. The document is in pdf or is converted to a pdf document

The user then selects among a list of a notaries' rubber stamps and seals to be applied to a specific location on their document.

For each rubber stamps or seal window of gif, tiff, png, pdf or any appropriate image format of the pages of the documents to be notarized is provided through a browser window or a Java applet. When the user clicks on the location of the image where the rubber stamp should be applied, the system captures the position of the point selected on the image and creates a new image obtained by applying on the foreground or the background of the originally displayed image the selected rubber stamps or seals. An example of technical implementation on a web site may be done through a Java applet or through coding in pdf with javascript or SVG and other languages or software components.

For the date and/or time, the system automatically computes the appropriate date and time and appends it to the location selected by the user on the original document or any of the previously notarized parts.

An electronic, signing, time stamping and notary method and system as disclosed in the present invention is very useful for various business contracting and legally mandated certifications. It is very clear that it would provide the following benefits to notaries as well as service user members:

A) Benefits of the invention for the notaries:

Reduced customer's identity verification risk,

Reduced notarized document forgery risk

Elimination of time spent to physically notarized the documents while preserving revenue making potential

B) Service User Member benefits

Elimination of need to physically find each time a document must be notarized a qualified notary who manually apposes a seal and sign/date, saving time and money.

The examples and embodiments described above are merely designed to practically teach the invention and should not be construed as limitations of its scope. In particular, while the system has been described as it relates to legislation in the US, its international application is also intended as similar laws as e-Sign have been enacted in most major countries throughout the world in recent years. Rather the extent of the invention should be seen as stated in the following claims:

1. A method for facilitating the electronic signing, time stamping or notarization of documents comprising the steps of:
a) initially identifying users of the method
b) subsequently authenticating those users
c) receiving submitted documents
d) signing, time stamping, editing or notarization by anyone of said users so as to give the appearance that anyone of those acts is of manually executed

2. The method of claim 1 further comprising the step of generating one or more digital fingerprints of documents created

3. The method of claim 2 further comprising the step of including time stamping information in the one or more digital fingerprints generated

4. The method of claim 2 further comprising the step of recording said one or more digital fingerprints of documents created

5. The method of claim 1 further comprising the step of generating one or more digital copies of documents created and sending them to either the service user member or a notary agent notarizing the document

6. The method of claim 1 further comprising the step of generating and recording a history log of editions to the submitted documents.

7. The method of claim 1 further comprising the step of enabling an auditor to verify the authenticity of a digital document by comparing its one or more fingerprints or history logs to those stored in a central database.

8. The method of claim 1 where the initially identified user of step a) is a notary and the identification step includes the step of verifying their identity and notary commission through a variety of methods, including:
a) production of complying notary commission documents
b) production of complying official picture bearing identification documents

9. The method of claim 8 where step of verifying the notary identity further includes a step of cross verification with local, state, provincial or federal government.

10. The method of claim 1 where the initially identified user of step a) is a service user member and the identification includes the step of having the service user member's identity physically verified by an identified commissioned notary

11. The method of claim 1 where the step of subsequently authenticating users of step b) includes using one or more methods from the list consisting of:
a) a login name
b) a login password
c) an e-mail address
d) a smart card
e) a biometric identifier

12. The method of claim 1 where the step of subsequently authenticating users signing, time stamping, editing or notarizing further includes enabling creation of customized seals.

13. The method of claim 1 where the step of subsequently authenticating users signing, time stamping, editing or notarizing further includes the step of apposing seals, signature image or time stamp to flexible locations of the submitted document.

14. The method of claim 1 wherein documents signed, time stamped, edited, notarized or authenticated include an inventor's notebook record or invention disclosure.

15. A system for facilitating the electronic signing, time stamping or notarization of documents comprising means for:
e) initially identifying users of the system
f) subsequently authenticating those users
g) receiving submitted documents
h) signing, time stamping, editing or notarization by anyone of said users so as to give the appearance that anyone of those acts is of manually executed

16. The system of claim 15 further comprising means for generating one or more digital fingerprints of documents created

17. The system of claim 16 further comprising the means for including time stamping information in the one or more digital fingerprints generated

18. The system of claim 16 further comprising means for recording said one or more digital fingerprints of documents created

19. The system of claim 15 further comprising means for generating one or more digital copies of documents created and sending them to either the service user member or a notary agent notarizing the document

20. The system of claim 15 further comprising means for generating and recording a history log of editions to the submitted documents.

21. The system of claim 15 further comprising means for enabling an auditor to verify the authenticity of a digital document by comparing its one or more fingerprints or history logs to those stored in a central database.

22. The system of claim 15 where the initially identified user of step a) is a notary and the identification step includes means for verifying their identity and notary commission through a variety of means, including:
a) means for production of complying notary commission documents
b) means for production of complying official picture bearing identification documents

23. The system of claim 22 where means for verifying the notary identity further includes means for cross verification with local, state, provincial or federal government.

24. The system of claim 15 where the initially identified user of step a) is a service user member and the identification includes means for having the service user member's identity physically verified by an identified commissioned notary

25. The system of claim 15 where the means for subsequently authenticating users of step b) includes using one or more choices from the list consisting of:
a) a login name
b) a login password
c) an e-mail address
d) a smart card
e) a biometric identifier

26. The system of claim 15 where means for subsequently authenticating users signing, time stamping, editing or notarizing further includes enabling creation of customized seals.

27. The system of claim 15 where means for subsequently authenticating users signing, time stamping, editing or notarizing further includes means for apposing seals, signature image or time stamp to flexible locations of the submitted document.

28. The system of claim 15 wherein documents signed, time stamped, edited,notarized or authenticated include an inventor's notebook record or invention disclosure.
